(19) United States
(12) Patent Application Publication
(10) Pub. No.: US 2025/0182499 A1
(43) Pub. Date: Jun. 5, 2025

(54) SURVEILLANCE APPARATUS, SURVEILLANCE METHOD, AND NON-TRANSITORY COMPUTER-READABLE MEDIUM

(71) Applicant: NEC Corporation, Minato-ku, Tokyo (JP)

(72) Inventors: Shihono MOCHIZUKI, Tokyo (JP); Satoshi TERASAWA, Tokyo (JP); Ryuji WAKAKUSA, Tokyo (JP); Maki MUROTA, Tokyo (JP); Sayaka IKEDA, Tokyo (JP)

(73) Assignee: NEC Corporation, Minato-ku, Tokyo (JP)

(21) Appl. No.: 18/844,185

(22) PCT Filed: Mar. 17, 2022
(86) PCT No.: PCT/JP2022/012238

§ 371 Date: Sep. 5, 2024

(51) Int. Cl. G06V 20/59; G06V 20/52

(52) U.S. Cl. CPC G06V 20/59; G06V 20/52

(57) ABSTRACT

A surveillance apparatus (100) includes: a biometric information acquisition unit (102) that acquires biometric information about a target person present in a predetermined space; an image acquisition unit (104) that acquires an image including the target person and surroundings of the target person; a decision unit (106) that decides whether the biometric information satisfies a first criterion and a state of other person located around the target person satisfies a second criterion; and an output processing unit (108) that outputs predetermined information when it is decided that both of the first criterion and the second criterion are satisfied.

### TECHNICAL FIELD

The present invention relates to a surveillance system, a surveillance apparatus, a surveillance method, and a storage medium.

### BACKGROUND ART

In recent years, crimes and trouble in a moving vehicle occur one after another, and a measure to prevent a crime is urgent necessity. Further, a crime such as kidnapping of young people also frequently occurs in some regions.

One example of a trouble handling system in a train is described in Patent Document 1. The system in Patent Document 1 includes a first input unit that inputs a detection result of detecting a change in biometric information (such as a heart rate) about a target person such as a passenger by using a sensor provided in a car, a second input unit that inputs a recognition result of a recognition apparatus that recognizes a movement of the target person, and a processing unit that determines whether trouble is occurring, based on an input result of the first input unit and the second input unit, and performs processing (for example, an in-car announcement, and the like) according to the movement of the target person.

Patent Document 2 describes one example of an image processing apparatus that estimates a danger level when an undetermined large number of people gathers at an event site and the like. The image processing installation described in Patent Document 2 includes a congestion analysis unit that estimates a degree of congestion of people, based on a captured image, an attribute analysis unit that estimates an attribute of a person, based on the captured image, a danger level analysis unit that estimates a danger level, based on the degree of congestion and the attribute of the person, and a display processing unit that performs control in such a way as to display various types of information on a display unit, and the display processing unit displays a screen indicating the danger level.

Patent Document 3 describes an information processing method capable of deciding whether a target person is performing suspicious behavior, based on a captured image of the target person, by using a learning model. Patent Document 4 describes a video surveillance apparatus including a camera video acquisition unit that acquires surveillance video information, a trouble detection unit that extracts a plurality of person regions from the surveillance video information, obtains a visual line direction of a person for each of the person regions, and detects occurrence of a phenomenon of interest by discriminating that visual line directions of a plurality of persons are directed to a specific position, and an output apparatus that notifies occurrence of the phenomenon of interest.

Patent Document 5 describes a surveillance system for surveying the inside of a car of a train. The surveillance system in Patent Document 5 detects a person present in a vehicle, based on video data captured by a surveillance camera or video data recorded in a recording apparatus, and decides a vehicle occupancy rate A from detection of a proportion of occupancy of the person in the vehicle. Further, the surveillance system measures the number of people who get on and off, based on video data captured by a surveillance camera or video data recorded in a recording apparatus, and decides a vehicle occupancy rate B from the number of people who are currently getting on with respect to a maximum number of people who can get on. Then, a highly accurate vehicle occupancy rate is decided by taking an average value from the vehicle occupancy rates computed by the two ways of the methods, and the like.

Patent Document 6 describes an in-car surveillance apparatus that can prevent a passenger from falling down in a vehicle of public transportation aimed at transporting a great number of passengers. The in-car surveillance apparatus in Patent Document 6 includes a riding state recognition unit that recognizes a riding state of a passenger, a traveling state recognition unit that recognizes a traveling state of a vehicle, and a notification unit that provides notification about safety of the passenger, based on the riding state and the traveling state.

### RELATED DOCUMENTS

### Patent Documents

Patent Document 1: Japanese Patent Application Publication No. 2018-106729

Patent Document 2: Japanese Patent Application Publication No. 2019-200715

Patent Document 3: Japanese Patent Application Publication No. 2021-164008

Patent Document 4: Japanese Patent Application Publication No. 2018-148402

Patent Document 5: Japanese Patent Application Publication No. 2013-25523

Patent Document 6: Japanese Patent Application Publication No. 2016-62414

### SUMMARY OF INVENTION

### Technical Problem

The techniques described in Patent Documents described above relate to a technique for detecting occurrence of trouble in a predetermined space of a vehicle and the like, and providing notification. While many techniques are proposed, the inventor has discussed a contrivance to accurately detect occurrence of an incident and efficiently provide notification.

One example of an object of the present invention is, in view of the problem described above, to provide a surveillance system, a surveillance apparatus, a surveillance method, and a storage medium that solve a problem of accuracy improvement of detection and notification of occurrence of an incident in a predetermined space.

### Solution to Problem

An example aspect of the present invention provides a surveillance apparatus including:

a biometric information acquisition unit that acquires biometric information about a target person present in a predetermined space;

an image acquisition unit that acquires an image including the target person and surroundings of the target person;

a decision unit that decides whether the biometric information satisfies a first criterion and a state of other person located around the target person satisfies a second criterion; and

an output processing unit that outputs predetermined information when it is decided that both of the first criterion and the second criterion are satisfied.

An example aspect of the present invention provides a surveillance system including:

a capturing unit; and

a surveillance apparatus, wherein

the surveillance apparatus includes
a biometric information acquisition unit that acquires biometric information about a target person present in a predetermined space,
an image acquisition unit that acquires an image including the target person and surroundings of the target person from the capturing unit,
a decision unit that decides whether the biometric information satisfies a first criterion and a state of other person located around the target person satisfies a second criterion, and
an output processing unit that outputs predetermined information when it is decided that both of the first criterion and the second criterion are satisfied.

An example aspect of the present invention provides a surveillance method including:

acquiring biometric information about a target person present in a predetermined space;

acquiring an image including the target person and surroundings of the target person;

deciding whether the biometric information satisfies a first criterion and a state of other person located around the target person satisfies a second criterion; and

outputting predetermined information when it is decided that both of the first criterion and the second criterion are satisfied.

An example aspect of the present invention provides a computer-readable storage medium that stores a program for causing a computer to execute:

a procedure of acquiring biometric information about a target person present in a predetermined space;

a procedure of acquiring an image including the target person and surroundings of the target person;

a procedure of deciding whether the biometric information satisfies a first criterion and a state of other person located around the target person satisfies a second criterion; and

a procedure of outputting predetermined information when it is decided that both of the first criterion and the second criterion are satisfied.

Note that, another aspect of the present invention may be a program causing at least one or more computers to execute the method in the example aspect described above, or may be a computer-readable storage medium that stores such a program. The storage medium includes a non-transitory tangible medium.

The computer program includes a computer program code causing a computer to execute the surveillance method on the surveillance apparatus when the computer program code is executed by the computer.

Note that, any combination of the components above and expression of the present invention being converted among a method, an apparatus, a system, a storage medium, a computer program, and the like are also effective as a manner of the present invention.

Further, various components according to the present invention do not necessarily need to be an individually independent presence, and a plurality of components may be formed as one member, one component may be formed of a plurality of members, a certain component may be a part of another component, a part of a certain component and a part of another component may overlap each other, and the like.

Further, a plurality of procedures are described in an order in the method and the computer program according to the present invention, but the described order does not limit an order in which the plurality of procedures are executed. Thus, when the method and the computer program according to the present invention are executed, an order of the plurality of procedures can be changed within an extent that there is no harm.

Furthermore, a plurality of procedures of the method and the computer program according to the present invention are not limited to being executed at individually different timings. Thus, another procedure may occur during execution of a certain procedure, an execution timing of a certain procedure and an execution timing of another procedure may partially or entirely overlap each other, and the like.

### Advantageous Effects of Invention

An example aspect of the present invention can provide a surveillance system, a surveillance apparatus, a surveillance method, and a storage medium that solve a problem of accuracy improvement of detection and notification of occurrence of an incident in a predetermined space.

### BRIEF DESCRIPTION OF THE DRAWINGS

FIG. 1 It is a diagram illustrating an overview of a surveillance apparatus according to an example embodiment.

FIG. 2 It is a flowchart illustrating an operation example of the surveillance apparatus in FIG. 1.

FIG. 3 It is a diagram schematically illustrating a system configuration of a surveillance system according to the example embodiment.

FIG. 4 It is a block diagram illustrating a hardware configuration of a computer that implements the surveillance apparatus in FIG. 1.

FIG. 5 It is a diagram illustrating formation of other people with respect to a target person determined by a decision unit.

FIG. 6 It is a flowchart illustrating an operation example of the surveillance system according to the example embodiment.

FIG. 7 It is a functional block diagram illustrating a logical configuration example of a surveillance apparatus according to an example embodiment.

FIG. 8 It is a functional block diagram illustrating a logical configuration example of a surveillance apparatus according to an example embodiment.

FIG. 9 It is a flowchart illustrating one example of position determination processing of the surveillance apparatus according to the example embodiment.

FIG. 10 It is a functional block diagram illustrating a logical configuration example of a surveillance apparatus according to an example embodiment.

FIG. 11 It is a flowchart illustrating one example of output processing of a surveillance apparatus according to an example embodiment.

FIG. 12 It is a partial functional block diagram illustrating a main configuration of a surveillance apparatus according to an example embodiment.

FIG. 13 It is a diagram illustrating a data structure example of various types of information indicating an occurrence situation of an incident.

FIG. 14 It is a diagram illustrating a data structure example of analysis information.

### EXAMPLE EMBODIMENT

Hereinafter, example embodiments of the present invention will be described with reference to the drawings. Note that, in all of the drawings, a similar component has a similar reference sign, and description thereof will be appropriately not included. Further, in each of the following drawings, a configuration of a portion unrelated to essence of the present invention is not included and not illustrated.

“Acquisition” in an example embodiment includes at least one of acquisition (active acquisition), by its own apparatus, of data or information being stored in another apparatus or a storage medium, and inputting (passive acquisition) of data or information output from another apparatus to its own apparatus. Examples of the active acquisition include reception of a reply by making a request or an inquiry to another apparatus, reading by accessing another apparatus or a storage medium, and the like. Further, examples of the passive acquisition include reception of information to be distributed (transmitted, push-notified, or the like), and the like. Furthermore, “acquisition” may include acquisition by selection from among pieces of received data or pieces of received information, or reception by selecting distributed data or distributed information.

### Minimum Configuration Example

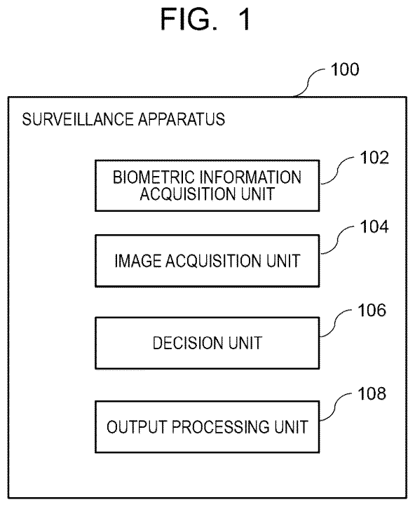

FIG. 1 is a diagram illustrating an overview of a surveillance apparatus 100 according to an example embodiment. The surveillance apparatus 100 includes a biometric information acquisition unit 102, an image acquisition unit 104, a decision unit 106, and an output processing unit 108.

The biometric information acquisition unit 102 acquires biometric information about a target person present in a predetermined space.

The image acquisition unit 104 acquires an image including the target person and surroundings of the target person.

The decision unit 106 decides whether the biometric information satisfies a first criterion and a state of other person located around the target person satisfies a second criterion.

The output processing unit 108 outputs predetermined information when it is decided that both of the first criterion and the second criterion are satisfied.

When both of the first criterion and the second criterion are satisfied in the decision by the decision unit 106, for example, it can be determined that an incident being some sort of state of emergency related to the target person occurs in the predetermined space. Thus, the output processing unit 108 can notify occurrence of the incident by performing processing of causing a predetermined output unit to output predetermined information.

### Operation Example

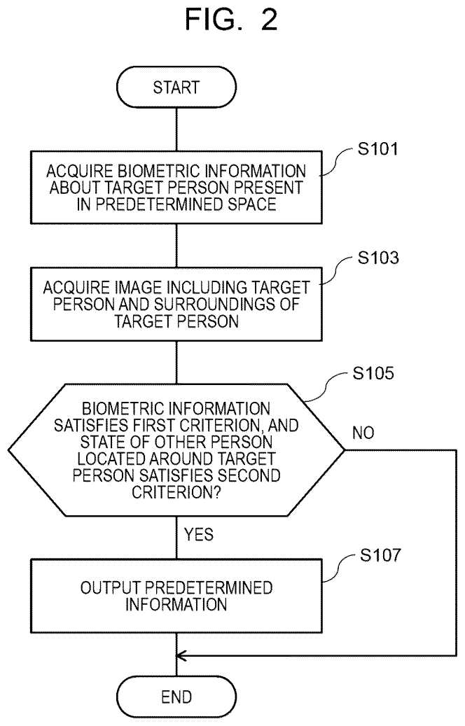

FIG. 2 is a flowchart illustrating an operation example of the surveillance apparatus 100 in FIG. 1.

First, the biometric information acquisition unit 102 acquires biometric information about a target person present in a predetermined space (step S101). The image acquisition unit 104 acquires an image including the target person and surroundings of the target person (step S103). The decision unit 106 decides whether the biometric information satisfies a first criterion and a state of other person located around the target person satisfies a second criterion (step S105). When the biometric information satisfies the first criterion and the state of the other person located around the target person satisfies the second criterion (YES in step S105), the output processing unit 108 outputs predetermined information (step S107). When the biometric information does not satisfy the first criterion or the state of the other person located around the target person does not satisfy the second criterion (NO in step S105), step S107 is bypassed, and the present processing ends.

As described above, in the surveillance apparatus 100, the biometric information acquisition unit 102 acquires biometric information about a target person present in a predetermined space, the image acquisition unit 104 acquires an image including the target person and surroundings of the target person, the decision unit 106 decides whether the biometric information satisfies a first criterion and a state of other person located around the target person satisfies a second criterion, and the output processing unit 108 outputs predetermined information when it is decided that both of the first criterion and the second criterion are satisfied.

With this configuration, by detecting occurrence of an incident, based on biometric information about a target person and a state of other person around the target person, and outputting predetermined information, occurrence of the incident can be notified. In other words, by detecting an abnormality of a target person from biometric information about the target person, and also detecting an abnormality of a state of other person around the target person, an occurrence situation of an incidence can be more accurately estimated. The surveillance apparatus 100 can solve a problem of accuracy improvement of detection and notification of occurrence of an incident in a predetermined space.

Hereinafter, a detailed example of the surveillance apparatus 100 will be described.

### First Example Embodiment

### System Overview

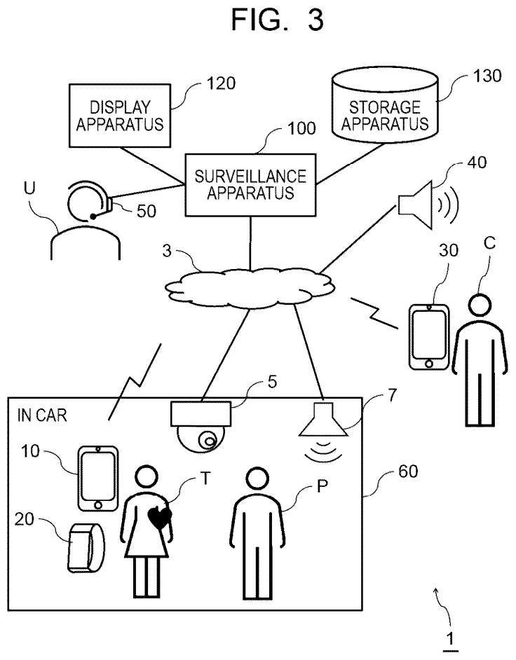

FIG. 3 is a diagram schematically illustrating a system configuration of a surveillance system I according to the example embodiment of the present invention. The surveillance system 1 surveys an incident occurring in a predetermined space, for example, the inside of a car of a moving vehicle 60 and the like. The incident includes, for example, a nuisance such as molestation, kidnapping, theft, robbery, bag-snatching, intimidation, a threat, bluster, violence, carrying of a dangerous article, occurrence of a strange odor, and sneak photography, a criminal act, and the like.

The surveillance system 1 detects, from biometric information about a target person T, a state where the target person T is mentally unstable, a state of feeling fear, and a state of being tense due to occurrence of the incident. Then, the surveillance system 1 makes a report to a surveillance center and a manager according to a predetermined condition.

The surveillance system 1 includes the surveillance apparatus 100, a camera 5 that captures a predetermined space, and a target person portable terminal 10 of the target person T.

The settlement apparatus 100 includes a storage apparatus 130. The storage apparatus 130 may be provided inside the surveillance apparatus 100, or may be provided outside. In other words, the storage apparatus 130 may be hardware integral with the surveillance apparatus 100, or may be hardware separated from the surveillance apparatus 100.

The camera 5 includes a lens and a capturing element such as a charge coupled device (CCD) image sensor, and is, for example, a network camera such as an Internet protocol (IP) camera. The network camera has, for example, a wireless local area network (LAN) communication function, and is connected to the surveillance apparatus 100 via a relay apparatus (not illustrated) such as a router of a communication network 3.

As one example, the camera 5 is provided on a ceiling of a predetermined space. The camera 5 may be a camera that can perform capturing in all directions by 360 degrees. As one example, the camera 5 is a camera equipped with a fisheye lens. Then, the camera 5 may include a mechanism for performing control of an orientation of a camera main body and a lens, zooming control, focusing control, and the like by following a movement of a person.

FIG. 3 illustrates only one camera 5, but the number of the cameras 5 is not limited to this. The plurality of cameras 5 may be used.

An image generated by the camera 5 is preferably captured in real time and transmitted to the surveillance apparatus 100. However, the image transmitted to the surveillance apparatus 100 may not be directly transmitted from the camera 5, and may be an image delayed by a predetermined time. The image captured by the camera 5 may be once stored in another storage apparatus 130, and may be read by the surveillance apparatus 100 from the storage apparatus 130 successively or by each predetermined interval. Furthermore, the image transmitted to the surveillance apparatus 100 is preferably a moving image, but may be a frame image by each predetermined interval or may be a still image.

The target person portable terminal 10 is a terminal carried by the target person T, and is, for example, a computer such as a portable personal computer, a smartphone, and a tablet terminal. The target person T may wear a wearable terminal 20 that acquires biometric information.

The wearable terminal 20 is assumed to be set in advance in such a way as to be communicable with the target person portable terminal 10 by short-distance communication, for example, Bluetooth (registered trademark) and the like. The biometric information acquired by the wearable terminal 20 is transmitted to the surveillance apparatus 100 via the target person portable terminal 10. However, the biometric information may be directly transmitted from the wearable terminal 20 to the surveillance apparatus 100.

The biometric information includes at least one of a heart rate and an amount of perspiration. However, the biometric information is not limited to this, and may include a body temperature, blood pressure, a respiration rate, a blood oxygen level, and the like. For example, the biometric information such as a heart rate and an amount of perspiration is used for deciding whether a psychological state of the target person T is in a tense state. Thus, the biometric information may be other information as long as the biometric information is information that can determine a psychological state of the target person T. The wearable terminal 20 includes a sensor that measures at least one of a heart rate and an amount of perspiration of the target person T, and also includes a function of transmitting a measured value to the target person portable terminal 10 or the surveillance apparatus 100.

The surveillance system 1 may further include a display apparatus 120. The display apparatus 120 is connected to the surveillance apparatus 100. The display apparatus 120 is, for example, a liquid crystal display, an organic electroluminescence (EL) display, and the like, which is not limited thereto. The display apparatus 120 may be provided on a surveillance board installed at a surveillance center and the like, for example. An operator U can survey a situation in a predetermined space by viewing the display apparatus 120. The operator U may be able to listen to a sound output from the surveillance apparatus 100 by wearing a headphone 50. Further, the headphone 50 may be paired with a microphone, and may be able to be used for a call to a station employee C on station premises, for example.

The surveillance system 1 may further include at least one of an in-car speaker 7 and an on-premises speaker 40. The in-car speaker 7 and the on-premises speaker 40 are each connected to the surveillance apparatus 100.

In the example embodiment, a predetermined space being a surveillance target is the inside of a moving vehicle 60.

The surveillance system 1 may further include a station employee terminal 30 carried by the station employee C. The station employee terminal 30 is, for example, a computer such as a portable personal computer, a smartphone, and a tablet terminal.

In order to notify a conductor and a driver of a crime and the like in a car, an emergency report button may be installed. However, the emergency report button installed in a car is often difficult to use under a situation where trouble actually occurs. In recent years, occurrence of crimes and the like in a car of the moving vehicle 60 is frequent, and a measure to prevent a crime is an urgent necessity, and thus occurrence of an incident in a car can be accurately detected and efficiently notified by targeting occurrence of an incident in a car.

A surveillance target is not limited to the vehicle 60, and may be the inside of a predetermined facility, for example, a facility for elderly people, a nursery school, a kindergarten, and the like. In the example embodiment, since the vehicle 60 is a surveillance target, description is given with reference to the station employee C and the station employee terminal 30, but, in an example of another facility, description can be given with reference to a staff member of the facility and an operation terminal carried by a staff member.

For use of the surveillance system 1, the target person T performs use registration of a service of the surveillance system 1 in advance. As a use method of the service, for example, a method for installing and activating a predetermined application in the target person portable terminal 10 of the target person T, accessing a predetermined web site by using a browser and the like in the target person portable terminal 10, and the like is conceivable.

The surveillance system 1 may be a so-called server-client system. In that case, the surveillance apparatus 100 functions as a server connected to each of the terminal 10 and the terminal 30 via the communication network 3, and each of the terminal 10 and the terminal 30 functions as a client terminal. Note that, a function of the surveillance apparatus 100 may be in a form (for example, software as a service (Saas), platform as a service (PaaS), HaaS or IaaS (hardware/infrastructure as a service), and the like) implemented by accessing a server on a cloud from each of the terminal 10 and the terminal 30 via the Internet.

Alternatively, a service provided by the surveillance apparatus 100 may be able to be used on each of the terminal 10 and the terminal 30 by accessing a predetermined uniform resource locator (URL) from each of the terminal 10 and the terminal 30 and performing a login. Herein, the service provided by the surveillance apparatus 100 includes surveying a situation in a predetermined space in which the target person T is present, notifying the station employee C and the operator U at a surveillance center according to the situation, and the like.

### Hardware Configuration Example

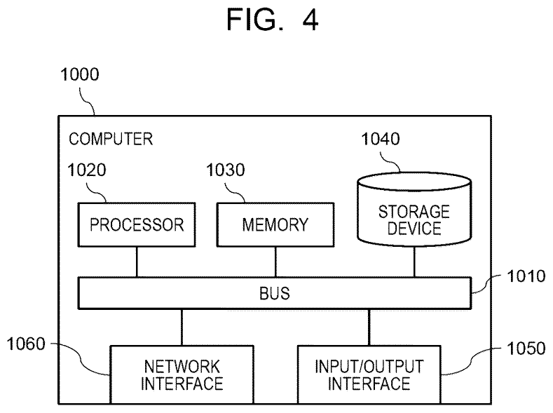

FIG. 4 is a block diagram illustrating a hardware configuration of a computer 1000 that implements the surveillance apparatus 100 in FIG. 1. The target person portable terminal 10, the wearable terminal 20, the station employee terminal 30, and the like in FIG. 3 are also implemented by the computer 1000. Further, the function of the surveillance apparatus 100 may be implemented by being shared between the computer 1000 that implements the surveillance apparatus 100 and the computer 1000 that implements the target person portable terminal 10 or the station employee terminal 30. The computer 1000 that implements each apparatus and each terminal may be plural.

The computer 1000 includes a bus 1010, a processor 1020, a memory 1030, a storage device 1040, an input/output interface 1050, and a network interface 1060.

The bus 1010 is a data transmission path for allowing the processor 1020, the memory 1030, the storage device 1040, the input/output interface 1050, and the network interface 1060 to transmit and receive data with one another. However, a method for connecting the processor 1020 and the like to one another is not limited to bus connection.

The processor 1020 is a processor implemented by a central processing unit (CPU), a graphics processing unit (GPU), and the like.

The memory 1030 is a main storage apparatus implemented by a random access memory (RAM) and the like.

The storage device 1040 is an auxiliary storage apparatus implemented by a hard disk drive (HDD), a solid state drive (SSD), a memory card, a read only memory (ROM), or the like. The storage device 1040 stores a program module that achieves each function (for example, the biometric information acquisition unit 102, the image acquisition unit 104, the decision unit 106, and the output processing unit 108, and an estimation unit 110 and a determination unit 112 that will be described below, and the like) of the surveillance apparatus 100. The processor 1020 reads each program module onto the memory 1030 and executes the program module, and each function associated with the program module is achieved. Further, the storage device 1040 may also store each piece of data of the storage apparatus 130 of the surveillance apparatus 100.

The program module may be stored in a storage medium. The storage medium that stores the program module may include a non-transitory tangible medium usable by the computer 1000, and a program code readable by the computer 1000 (the processor 1020) may be embedded in the medium.

The input/output interface 1050 is an interface for connecting the computer 1000 and various types of input/output equipment. The input/output interface 1050 also functions as a communication interface that performs short-range wireless communication, such as Bluetooth (registered trademark) and Near Field Communication (NFC).

The network interface 1060 is an interface for connecting the computer 1000 to a communication network. The communication network is, for example, a local area network (LAN) and a wide area network (WAN). A method of connection to the communication network by the network interface 1060 may be wireless connection or wired connection.

Then, the computer 1000 is connected to necessary equipment (for example, the display apparatus 120, the headphone 50, the camera 5, and the in-car speaker 7 connected to the surveillance apparatus 100, or a display, an operation unit (or a touch panel), a camera, a speaker, and a microphone of the target person portable terminal 10 and the station employee terminal 30, a display, an operation unit (or a touch panel), a speaker, a microphone, various sensors that acquire biometric information of the wearable terminal 20, and the like) via the input/output interface 1050 or the network interface 1060.

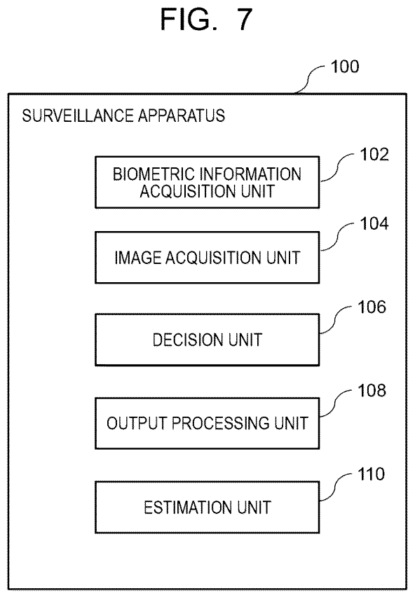

Each component of the surveillance apparatus 100 according to each example embodiment in FIG. 1 and FIGS. 7, 8, and 10 described below is achieved by any combination of hardware of the computer 1000 in FIG. 4 and software. Then, various modification examples of an achievement method and an apparatus thereof are understood by a person skilled in the art. A functional block diagram illustrating the surveillance apparatus 100 according to each example embodiment illustrates a block of logical functional units instead of a configuration of hardware units.

### Functional Configuration Example

Hereinafter, a function of the surveillance apparatus 100 will be described by using FIG. 1. The biometric information acquisition unit 102 acquires biometric information about a target person present in a predetermined space. As described above, in the example embodiment, the predetermined space is the inside of a car of the moving vehicle 60. The biometric information includes at least one of a heart rate and an amount of perspiration of the target person T. The biometric information acquisition unit 102 acquires the biometric information about the target person T from the target person portable terminal 10 worn by the target person T.

A timing at which the biometric information acquisition unit 102 acquires the biometric information is, for example, at least any one of a timing at which the target person T specifies a use start of a service of the surveillance system 1 (for example, at a timing at which the target person T activates an application by the target person portable terminal 10 or at a timing at which the target person T specifies a use start by pressing a use start button on an application, and the like), a timing at which it is detected that the target person T rides in a car of the moving vehicle 60, and any timing while the target person T is present in a car of the moving vehicle 60.

Various methods for detecting that the target person T rides in a car of the moving vehicle 60 and is present in a car are conceivable and exemplified below, which are not limited thereto. For example, a general check-in detection technique to a predetermined area can be used. Note that, a plurality of the following examples may be combined.
(a1) Communication with a wireless communicator (not illustrated) installed in the moving vehicle 60 is detected by using a short-distance wireless communication function such as Bluetooth (registered trademark) of the target person portable terminal 10 of the target person T.
(a2) Communication with an access point (not illustrated) of a wireless local area network (LAN) installed in the moving vehicle 60 is detected by using a wireless communication function such as the wireless LAN of the target person portable terminal 10 of the target person T.
(a3) A predetermined sound wave output from a sound wave generator (not illustrated) installed in the moving vehicle 60 is received by a microphone (not illustrated) of the target person portable terminal 10 of the target person T.

An application for detecting a check-in to a predetermined area by a method such as (a1) to (a3) is installed and activated in the target person portable terminal 10 in advance. By providing notification about detection of communication and reception of a sound wave from the application to the surveillance apparatus 100, the target person portable terminal 10 determines a check-in area of the target person portable terminal 10.

Furthermore, the following examples are also exemplified as other examples.
(a4) Riding of the target person T is detected by verifying the target person T with preregistered biometric authentication information about the target person T by using the camera 5 that captures the inside of the moving vehicle 60. Alternatively, a riding position of the target person T is determined by tracking the riding position by using a captured image of a camera (not illustrated) installed on station premises.
(a5) Position registration information with a base station in a cellular phone communication network of the target person portable terminal 10 is used.
(a6) A current position of the target person portable terminal 10 determined by a global positioning system (GPS) reception function of the target person portable terminal 10 is used.

The image acquisition unit 104 acquires an image including a target person and surroundings of the target person from the camera 5 installed in the moving vehicle 60. A timing at which the image acquisition unit 104 acquires an image is at least a timing at which a decision result that biometric information satisfies a first criterion is acquired by the decision unit 106.

The decision unit 106 decides whether the biometric information about the target person T being acquired by the biometric information acquisition unit 102 satisfies the first criterion and a state of other person located around the target person T satisfies a second criterion.

The first criterion is, for example, a condition that at least one of a heart rate and an amount of perspiration being the biometric information about the target person T exceeds a threshold value. In other words, the first criterion is a condition that the biometric information is a value indicating the target person T in a tense state or a state of feeling fear. Alternatively, the first criterion may include a condition that the biometric information is a value indicating a sudden change from a certain state (steady state). For example, the first criterion may include a condition that a range of fluctuation within a predetermined period of time of the biometric information exceeds a threshold value. Further, the first criterion may further include a condition that a state where the first criterion is satisfied continues for a predetermined period or longer.

In this way, the biometric information acquisition unit 102 can acquire at least one of a heart rate and an amount of perspiration as the biometric information about the target person T, and the decision unit 106 can perform decision processing, and thus a state of the target person T when the target person T is a victim can be estimated and accurately detected. Under a situation where the target person T is being a victim, there are many cases where the target person T himself/herself cannot make a report. Further, as described in an example embodiment described below, a sensor needs to be provided separately in a car in order to acquire biometric information about a perpetrator. Thus, for example, women, young people, and the like who are more likely to be a victim wear the wearable terminal 20 and use a service of the surveillance system 1, and thus the biometric information acquisition unit 102 can acquire the biometric information about the target person T. Therefore, occurrence of an incident can be accurately and efficiently detected.

The decision unit 106 determines a state of other person located around the target person T by performing image analysis processing on an image acquired by the image acquisition unit 104

The other person thresholding around the target person T may be a person present in the same region as the target person T being acquired by, for example, dividing a predetermined space into a plurality of regions. Various methods for acquiring position information about the target person T are conceivable. For example, (a1) to (a3) described above, a general check-in detection technique to a predetermined area, or a method for acquiring current position information of (a4) to (a6) can be used. The function of acquiring position information about the target person T can be achieved by a determination unit 112 according to a third example embodiment described below.

One example of the second criterion is a condition that a degree of congestion in a predetermined space is equal to or more than a reference value. For example, the decision unit 106 measures the number of passengers present in a car by using an image of the inside of a car of the moving vehicle 60. As one example, the image acquisition unit 104 acquires an image in which a gate of the moving vehicle 60 is captured by the camera 5, and the decision unit 106 performs the image analysis processing, counts the number of people who get on and off, and computes the number of people present in a car of the moving vehicle 60. In another example, the image acquisition unit 104 acquires an image in which the inside of a car of the moving vehicle 60 is captured by the camera 5, and the decision unit 106 performs image processing, detects and counts a head of a passenger, and computes the number of people present in the car of the moving vehicle 60.

The decision unit 106 may convert the computed number of the passengers into the number of people per unit area by dividing the computed number by an area of the predetermined space, and set the number of people per unit area as a degree of congestion. The decision unit 106 may compute a vehicle occupancy rate from the computed number of the passengers and the number of people that can be accommodated in the moving vehicle 60, and set the vehicle occupancy rate as a degree of congestion.

In another example, the decision unit 106 may decide whether a degree of congestion in a part of a region in a predetermined space around the target person T is equal to or more than a reference value. For example, the decision unit 106 may divide the moving vehicle 60 into a plurality of regions, determine a degree of congestion or the number of passengers for each region, and decide that the degree of congestion is equal to or more than a reference value when the degree of congestion or the number of passengers in a region where the target person T is present is greater than another region by a certain proportion or more.

When it is particularly congested, the second criterion preferably includes the target person T surrounded by a plurality of people.

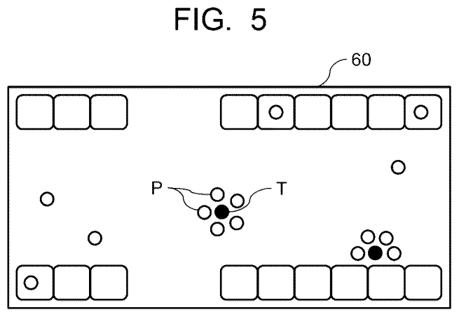

The decision unit 106 determines formation of a plurality of people present around the target person T by performing the image analysis processing on an image acquired by the image acquisition unit 104. As illustrated in FIG. 5, for example, the decision unit 106 determines whether formation is a round shape or a fan shape in which the target person T (indicated by a black dot in FIG. 5) is surrounded by a plurality of other persons P (indicated by a white dot in FIG. 5).

When formation of the other persons P around the target person T is a round shape or a fan shape, the output processing unit 108 outputs predetermined information.

In this way, the decision unit 106 can detect occurrence of an incident by performing the decision processing with, as the second criterion, a condition that a degree of congestion in a predetermined space is equal to or more than a reference value, and can thus efficiently detect a crime, a nuisance, and the like committed by perpetrators in a group surrounding the target person T.

Furthermore, the decision unit 106 may determine a direction in which the plurality of persons P around the target person T face by the image processing, compute a proportion of the persons P facing the target person T, and decide whether the proportion is equal to or more than a reference value. When it is decided that the proportion of the persons P facing the target person T is equal to or more than the reference value, the output processing unit 108 may output predetermined information.

In still another example, the second criterion may include a condition that a distance between the target person T and the other person P is equal to or less than a reference value.

The decision unit 106 may measure a distance between the target person T and the other person P from position information about the target person T and the other person P by performing the image analysis processing on an image acquired by the image acquisition unit 104, and determine that the distance is equal to or less than the reference value, i.e., the target person T and the person T are close.

In this way, the decision unit 106 can detect occurrence of an incident by performing the decision processing with, as the second criterion, a condition that a distance between the target person T and the other person P is equal to or less than a reference value, and can thus efficiently detect a situation where a perpetrator is directly inflicting harm on the target person T, and the like.

The output processing unit 108 outputs predetermined information when it is decided that both of the first criterion and the second criterion are satisfied. For example, when it is decided that both of the first criterion and the second criterion are satisfied, occurrence of a predetermined incident is assumed to be determined, and the output processing unit 108 outputs information that notifies occurrence of the incident as the predetermined information.

The predetermined information includes, for example, information including at least one of a type of an occurring incident, a date and time of occurrence, a place of occurrence (for example, a route name and a destination, a section (such as a station name), a vehicle position (a vehicle number, a door number), and the like), and an image used for determining occurrence of the incident. Furthermore, the predetermined information includes a message that notifies occurrence of the incident.

An output destination of the output processing unit 108 includes at least any one of the display apparatus 120, the station employee terminal 30, the target person portable terminal 10, the in-car speaker 7, and the on-premises speaker 40. Predetermined information to be output may be changed according to an output destination. An output manner includes at least one of a sound output, a warning sound output, image display, message display, lamp lighting, and driving of a rotating light.

### Operation Example

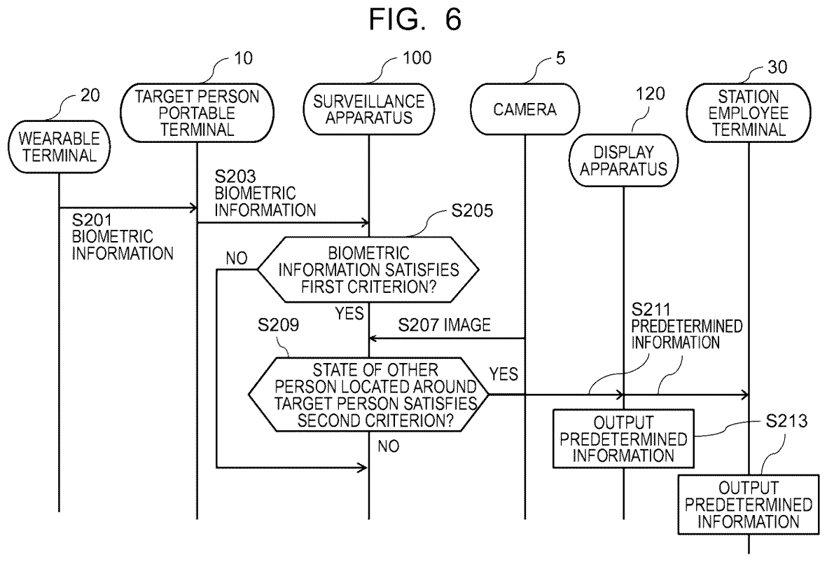

FIG. 6 is a flowchart illustrating an operation example of the surveillance system 1 according to the example embodiment.

The present flow is assumed to start at a timing of detection that the target person T rides in a car of the moving vehicle 60. However, a timing of a start of the flow is not limited to this, and may be any above-described timing of acquisition of the biometric information.

First, the biometric information acquisition unit 102 of the surveillance apparatus 100 requests the biometric information about the target person T from the target person portable terminal 10 of the target person T. The target person portable terminal 10 of the target person T regularly communicates with the wearable terminal 20, and acquires the biometric information about the target person T (step S201). In response to the request from the surveillance apparatus 100, the target person portable terminal 10 transmits, to the surveillance apparatus 100, the biometric information acquired from the wearable terminal 20, and the biometric information acquisition unit 102 of the surveillance apparatus 100 acquires the biometric information about the target person T from the target person portable terminal 10 (step S203).

Then, the decision unit 106 decides whether the acquired biometric information about the target person T satisfies a first criterion (step S205). For example, when a heart rate of the target person T exceeds a threshold value, it is decided that the biometric information satisfies the first criterion (YES in step S205), and the image acquisition unit 104 acquires an image of a predetermined space from the camera 5 (step S207).

Then, the decision unit 106 decides whether a state of the other person P located around the target person T satisfies a second criterion (step S209). For example, the decision unit 106 counts the number of the other persons P present in the same region as a region where the target person T is present by performing the image analysis processing on the image acquired in step S207, and decides whether the number of the other persons P is equal to or more than a reference value. When the number of the other persons P is equal to or more than the reference value (YES in step S209), the output processing unit 108 transmits predetermined information to at least one of the display apparatus 120 at a surveillance center and the station employee terminal 30 (step S211), and causes at least one of the display apparatus 120 at the surveillance center and the station employee terminal 30 to output the predetermined information (step S213).

As described above, according to the present example embodiment, in the surveillance apparatus 100, the biometric information acquisition unit 102 acquires biometric information about a target person present in a predetermined space, the image acquisition unit 104 acquires an image including the target person and surroundings of the target person, the decision unit 106 decides whether the biometric information satisfies a first criterion and a state of other person located around the target person satisfies a second criterion, and the output processing unit 108 outputs predetermined information when it is decided that both of the first criterion and the second criterion are satisfied.

With this configuration, by detecting occurrence of an incident, based on biometric information about a target person and a state of other person around the target person, and outputting predetermined information, occurrence of the incident can be notified. In other words, by detecting an abnormality of a target person from biometric information about the target person, and also detecting an abnormality of a state of other person around the target person, an occurrence situation of an incidence can be more accurately estimated. The surveillance apparatus 100 can solve a problem of accuracy improvement of detection and notification of occurrence of an incident in a predetermined space.

### Second Example Embodiment

### Functional Configuration Example

FIG. 7 is a functional block diagram illustrating a logical configuration example of a surveillance apparatus 100 according to an example embodiment. The present example embodiment is similar to the example embodiment described above except for a point of a configuration in which an attribute of a target person T and other person P is estimated by image processing. The surveillance apparatus 100 illustrated in FIG. 7 further includes an estimation unit 110 in addition to the configuration of the surveillance apparatus 100 in FIG. 1. However, the configuration of the present example embodiment can be combined as long as the present example embodiment is not inconsistent with at least any one of configurations of other example embodiments.

The estimation unit 110 estimates an attribute of each of the target person T and the other person P by the image processing. A second criterion includes a condition related to an attribute.

A decision unit 106 decides whether the second criterion is satisfied, based on an estimation result of the estimation unit 110.

An attribute includes a condition related to at least one of gender and an age group of at least one of the target person T and the other person P.

A condition related to an attribute is exemplified below, which is not limited thereto. Further, a plurality of the following examples may be combined.
(b1) Genders of the target person T and the other person P are different.
(b2) A probability of different genders of the target person T and the other person P is equal to or more than a reference value.
(b3) Age of the target person T is equal to or less than a first criterion value, and age of the other person P is the first criterion value or is equal to or more than a second criterion value higher than the first criterion value.

Herein, the first criterion value may be, for example, six years old by assuming the target person T to be an infant, and the second criterion value may be 18 years old by assuming the other person P to be older than a juvenile.

Note that, even when the target person T and the other person P are the same gender, an output processing unit 108 can output predetermined information in a case where another second criterion that, for example, a distance between the target person T and the other person P is equal to or less than a reference value and the like is satisfied.

The estimation unit 110 may further estimate a relationship between the target person T and the other person P by the image processing. For example, the estimation unit 110 may estimate whether the target person T and the other person P are a family from presence or absence of a movement and a conversation of the target person T and the other person P, and the like. For example, when a calm conversation, a movement such as a pat on a head, and the like are detected, the estimation unit 110 may estimate that the target person T and the other person P are a family.

Further, a movement used for estimating that the target person T and the other person P are not a family may include a movement of the target person T raising both arms (holding up), a movement of the other person P holding a dangerous weapon, brandishing a dangerous weapon, or holding a dangerous weapon ready, a movement of the other person P using violence on the target person T, a movement of the other person P holding the target person T down, holding the target person T in arms, pulling the target person T, or dragging the target person T, and the like. When the movement is estimated, the estimation unit 110 can estimate that the target person T and the other person P are not a family.

Furthermore, the estimation unit 110 may estimate a feeling of at least one of the target person T and the other person P by the image processing. The estimation unit 110 may detect a movement, a pose, an expression, a perspiration situation, a complexion, a body situation (shivering), and the like, and estimate a feeling of each person.

For example, when at least one of a feeling of the target person T indicating a feeling such as fear, anger, sadness, and discomfort, and a feeling of the other person P indicating a feeling such as excitement, anger, madness, and intimidation is estimated, the decision unit 106 determines that the second criterion is satisfied.

For example, a score may be set for each feeling, and the decision unit 106 may decide whether a feeling score exceeds a reference value.

As described above, the surveillance apparatus 100 according to the present example embodiment includes the estimation unit 110 that estimates an attribute of each of the target person T and the other person P by the image processing. The second criterion includes a condition related to an attribute. The decision unit 106 decides whether the second criterion is satisfied, based on an estimation result of the estimation unit 110.

In this way, the surveillance apparatus 100 according to the present example embodiment can achieve an effect similar to that in the example embodiment described above, and can also more accurately detect occurrence of an incident by further estimating an attribute of the target person T and the other person P, and adding a condition related to an attribute to decision processing of occurrence of an incident.

### Third Example Embodiment

### Functional Configuration Example

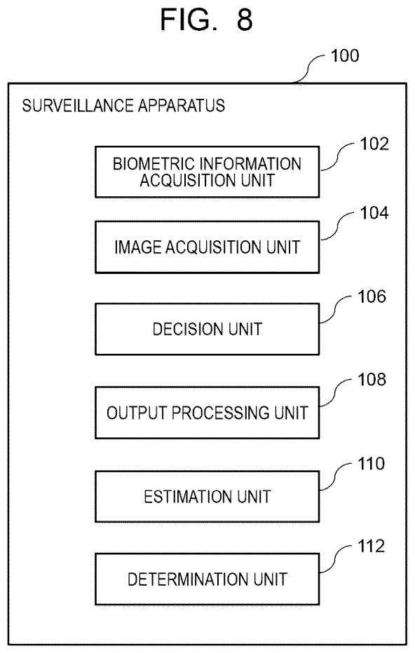

FIG. 8 is a functional block diagram illustrating a logical configuration example of a surveillance apparatus 100 according to an example embodiment. The present example embodiment is similar to the second example embodiment described above except for a point of a configuration for determining a position of a target person T by image processing. The surveillance apparatus 100 illustrated in FIG. 8 further includes a determination unit 112 in addition to the configuration of the surveillance apparatus 100 in FIG. 7. However, the configuration of the present example embodiment can be combined as long as the present example embodiment is not inconsistent with at least any one of configurations of other example embodiments except for the second example embodiment.

The determination unit 112 determines a position of the target person T when the target person T whose biometric information is decided to satisfy a first criterion is detected. The estimation unit 110 acquires an image including the determined position, and performs the image processing.

The determination unit 112 can determine a position of the target person T by using (a1) to (a3) described above, a general check-in detection technique to a predetermined area, or a method for acquiring current position information of (a4) to (a6).

### Operation Example

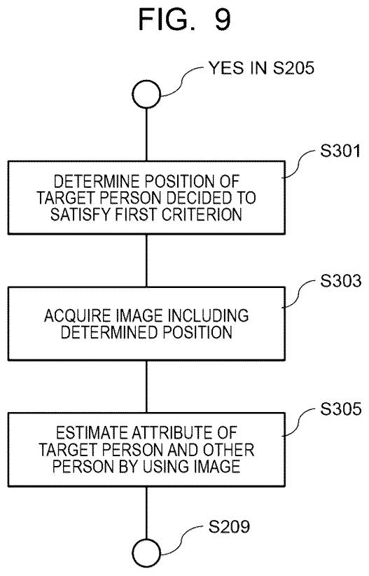

FIG. 9 is a flowchart illustrating one example of position determination processing of the surveillance apparatus 100 according to the example embodiment.

The present processing starts when the target person T whose biometric information satisfies a first criterion is detected in step S205 in the flowchart in FIG. 6 (YES in step S205). The determination unit 112 determines a position of the target person decided to satisfy the first criterion (step S301).

The estimation unit 110 requests an image including the determined position from a camera 5, and acquires the image (step S303). Note that, control of the camera 5 will be described in a fourth example embodiment described below. The estimation unit 110 estimates an attribute of the target person T and other person P by performing the image processing on the image acquired from the camera 5 (step S305).

As described above, the surveillance apparatus 100 according to the present example embodiment includes the determination unit 112 that determines a position of the target person T when the target person T whose biometric information is decided to satisfy the first criterion is detected. Then, the estimation unit 110 acquires an image including the determined position, and performs the image processing.

In this way, the surveillance apparatus 100 according to the present example embodiment can achieve an effect similar to that in the example embodiments described above, and can also determine a position of the target person T, then acquire an image focusing on the other person P present around the target person T, and use the image for attribute estimation processing and decision processing of occurrence of an incident. Thus, detection accuracy of occurrence of an incident can be improved.

### Fourth Example Embodiment

### Functional Configuration Example

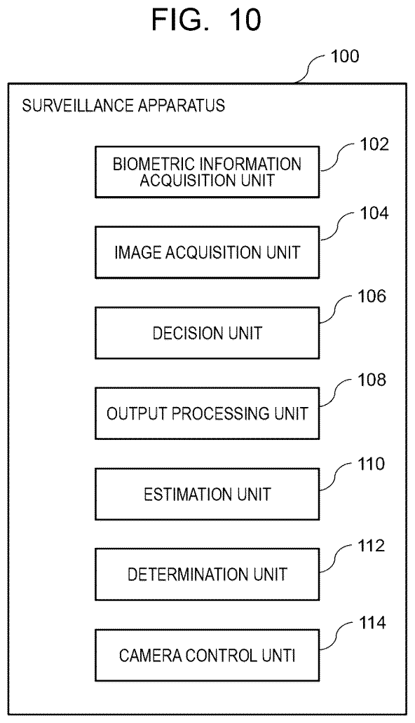

FIG. 10 is a functional block diagram illustrating a logical configuration example of a surveillance apparatus 100 according to an example embodiment. The present example embodiment is similar to the third example embodiment described above except for a point of a configuration for controlling a camera. The surveillance apparatus 100 illustrated in FIG. 10 further includes a camera control unit 114 in addition to the configuration of the surveillance apparatus 100 in FIG. 8. However, the configuration of the present example embodiment can be combined as long as the present example embodiment is not inconsistent with at least any one of configurations of other example embodiments except for the third example embodiment.

The camera control unit 114 directs a camera 5 toward a position determined by a determination unit 112, and causes the camera 5 to generate an image. An estimation unit 110 acquires the generated image, and performs image processing.

### Switching of Image Processing Method by Degree of Congestion

In the example embodiment described above, the decision unit 106 computes a degree of congestion in a predetermined space. By using the degree of congestion, the camera control unit 114 may have a configuration for changing an image to be generated by controlling the camera 5.

For example, when it is congested and when it is not congested, accuracy of the image processing of an image captured by the camera 5 changes. When it is not congested, a feeling can be estimated by zooming in a specific person and analyzing an expression of the person. The feeling estimation is as described in the second example embodiment. On the other hand, when it is congested, it is difficult to zoom in a specific person and analyze an expression of the person. The reason is that a portion where persons overlap each other increases, an image region that can be acquired for a specific person is reduced, and information to be acquired is thus reduced, and accuracy of an analysis result by the image processing decreases.

Thus, when a degree of congestion in a predetermined space is equal to or more than a reference value, a decision unit 106 performs decision processing by using, as a second criterion, a fact that the target person T is surrounded by a plurality of people by the image processing. At this time, the camera control unit 114 controls the camera 5 in such a way as to cause the camera 5 to generate an image at an angle of view from above in such a way that formation of the plurality of people in the predetermined space can be determined.

On the other hand, when a degree of congestion in a predetermined space is less than the reference value, the estimation unit 110 estimates an attribute of each of the target person T and other person P by the image processing, and the decision unit 106 performs the decision processing by using a condition related to an attribute as a second criterion. At this time, the camera control unit 114 controls the camera 5 in such a way that the camera 5 is directed in a direction of the target person T and the other person P in the predetermined space, adjusts a focus, and zooms in, as necessary. In this way, an image acquisition unit 104 can acquire a high-definition image, and thus estimation accuracy by the image processing of the estimation unit 110 improves.

As described above, the surveillance apparatus 100 according to the present example embodiment includes the camera control unit 114 that directs the camera 5 toward a position determined by the determination unit 112, and causes the camera 5 to generate an image. The estimation unit 110 acquires the generated image, and performs the image processing.

In this way, the surveillance apparatus 100 according to the present example embodiment can achieve an effect similar to that in the example embodiments described above, and can also switch an image to be generated according to a situation by controlling the camera 5 by the camera control unit 114. Thus, the image processing can be performed by using an image suitable for the decision processing and the estimation processing, and detection accuracy of occurrence of an incident improves.

### Fifth Example Embodiment

### Functional Configuration Example

The present example embodiment is similar to any of the example embodiments described above except for a point of a configuration in which an output processing unit 108 outputs caution information before predetermined information is output. Hereinafter, description is given by using the configuration of the fourth example embodiment in FIG. 10, but the configuration of the present example embodiment can be combined as long as the present example embodiment is not inconsistent with at least any one of configurations of other example embodiments except for the fourth example embodiment.

The output processing unit 108 outputs caution information toward a predetermined space before predetermined information is output, and outputs the predetermined information when a state where a first criterion and a second criterion are satisfied continues after the caution information is output.

Whether a state where the first criterion and the second criterion continues can be discriminated by, for example, repeating decision at a predetermined interval since a point in time at which at least any one of a state where a first criterion is satisfied and a state where a second criterion is satisfied, and discriminating that the first criterion and the second criterion are satisfied after a lapse of a predetermined period of time.

The caution information includes a voice message such as announcement output from an in-car speaker 7 installed in a car of a moving vehicle 60. The caution information is a message that calls attention to people present in a predetermined space. The message preferably includes at least one of a content that makes a perpetrator hesitate or give up a nuisance or a criminal act, and a content that prompts a person around a victim to recognize occurrence of an incident.

An example of the message includes “A nuisance such as molestation and a violent act are a crime.”, “When you see a nuisance such as molestation and a violent act, report to a conductor by pressing a report button in a car, or let a nearby security guard or railway police officer know.”, “You cannot bring a knife, a dangerous article, a thing emitting a bad odor, a thing that may inflict harm on other customers, a thing that may damage a car, and the like into the car.”, “When you see a foreign substance or a suspicious substance, let a nearby station employee know.”, and the like.

Furthermore, another example of the message may be a message that lets people present in a predetermined space know about a situation where occurrence of an incident is already suspected and a situation that has occurred. The message may include, for example, “Trouble seems to be occurring in a car. Please follow instructions from a conductor and act calmly.”, “A state of emergency is occurring. Please stay where you are until a conductor gives you instructions.”, and the like.

In other words, the predetermined information is information including intentions to report occurrence of an incident to the outside and request relief, and whereas the caution information includes information intended to make a perpetrator stop and give up an act or let a surrounding person know in a predetermined space in a situation where there is a sign of occurrence of an incident or an incident is occurring. In this way, the output processing unit 108 can switch information to be output in stages according to a situation.

The predetermined space is the inside of a car of a moving vehicle, and the output processing unit 108 outputs the predetermined information to at least one of a driver and a manager of the moving vehicle 60.

The manager includes, for example, the police, a security company, a staff member of a management facility and the like, and an operator at a surveillance center. The driver also includes a station employee C and a conductor.

The output processing unit 108 can select an output pattern in stages, and output the caution information and the predetermined information, according to a situation. The output pattern is exemplified below, which is not limited thereto. Further, a plurality of the following output patterns may be combined.
(c1) The caution information is announced in a car of the moving vehicle 60. For example, at least one of a sound output to the in-car speaker 7 installed in a vehicle and message display on a display (not illustrated) in a car is performed.
(c2) The predetermined information is output to a driver or a conductor of the moving vehicle 60 and the station employee C at a nearest station. For example, at least one of an output of a sound or a warning sound to the in-car speaker 7 installed on a driver's seat, message display on a display installed on a driver's seat, and lamp lighting is performed.
(c3) The predetermined information is output to an operator at a surveillance center. For example, at least one of display of an image and a message on a display apparatus 120 at a surveillance center, lamp lighting of a surveillance board, an output of a sound or a warning sound from a speaker installed at a surveillance center, driving of a rotating lamp installed at a surveillance center, and an output of a sound or a warning sound to a headphone 50 worn by an operator U is performed.
(c4) The predetermined information or the caution information is output to a station employee terminal 30 carried by the station employee C or a conductor.
(c5) The caution information is output to a portable terminal of another user except for a victim. The another user is a person who has performed use registration of a service of the surveillance system 1 and is present in the same moving vehicle 60.
(c6) A report is made to a manager including the police, a security company, and a staff member of a management facility and the like. For example, at least one of transmission of information about occurrence of an incident to a portable terminal carried by a manager and driving of a rotating lamp installed in a facility is performed.

### Operation Example

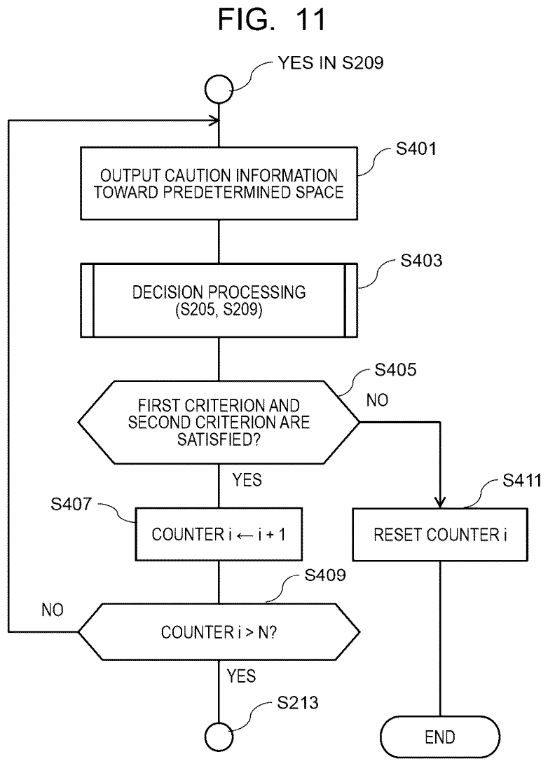

FIG. 11 is a flowchart illustrating one example of output processing of the surveillance apparatus 100 according to the example embodiment.

The processing in FIG. 11 starts when a decision unit 106 decides that biometric information about a target person T satisfies a first criterion in step S205 in FIG. 6 and the decision unit 106 decides that a state of other person P around the target person T satisfies a second criterion in step S209. Further, repetition (return to step S401 from step S409) of the present processing may be performed in a predetermined cycle (for example, an interval of one minute), and the like.

When the present processing starts, the output processing unit 108 outputs caution information toward a predetermined space (step S401). For example, a voice message that calls attention to a passenger is output from the in-car speaker 7, and the caution information is displayed on a display in a car.

Then, the decision unit 106 repeats the decision processing in step S205 and step S209 in FIG. 6 (step S403), and, when a decision result that the first criterion and the second criterion are satisfied is acquired as a result of the decision (YES in step S405), a counter i is incremented (step S407). Herein, in a case of a first time, 1 is set to the counter i.

Then, the decision unit 106 decides whether the counter i exceeds a predetermined value

N (step S409). The predetermined value N is a value for deciding whether the decision processing in step S205 and step S209 in FIG. 6 is repeatedly performed for a predetermined number N of times. When the counter i is equal to or less than the predetermined value N (NO in step S409), the processing returns to step S401, and the output processing unit 108 outputs the caution information toward the predetermined space. Alternatively, the processing may include a procedure of returning to step S403.

Then, the decision processing is repeated, and, when the counter i exceeds the predetermined value N in step S409 (YES in step S409), the processing proceeds to step S213 in FIG. 6, and the output processing unit 108 outputs predetermined information.

On the other hand, when it is decided that at least one of the first criterion and the second criterion is not satisfied in a decision result in step S405 (NO in step S405), the counter i is reset, and the present processing ends. At this time, when an output of the caution information by the output processing unit 108 continues (such as display on a display), the output of the caution information is stopped.

As described above, in the surveillance apparatus 100 according to the present example embodiment, the output processing unit 108 outputs caution information toward a predetermined space before predetermined information is output, and outputs the predetermined information when a state where a first criterion and a second criterion are satisfied continues after the caution information is output.

In this way, the surveillance apparatus 100 according to the present example embodiment can achieve an effect similar to that in the example embodiments described above, and can also switch output information in stages according to a situation in a predetermined space, and can thus improve an effect of the output information.

First, a criminal act and the like are suppressed by caution information directed to the inside of a car, and, when an incident is continuously detected, a request for dispatch and the like are performed by giving an alarm to the police and a security company, and thus a false alarm such as a request for dispatch to the police and a security company can be suppressed.

### Sixth Example Embodiment

### Functional Configuration Example

The present example embodiment is similar to any of the example embodiments described above except for a point of a configuration in which a biometric information acquisition unit 102 further acquires biometric information about a person P except for a target person T and performs decision processing by using biometric information about the other person P. Hereinafter, description is given by using the configuration of the fourth example embodiment in FIG. 10, but the configuration of the present example embodiment can be combined as long as the present example embodiment is not inconsistent with at least any one of configurations of other example embodiments except for the fourth example embodiment.

The biometric information acquisition unit 102 further acquires biometric information about other person.

A decision unit 106 decides whether the biometric information about the other person satisfies a third criterion.

An output processing unit 108 outputs predetermined information when the biometric information about the other person satisfies the third criterion.

An example of the other person P includes a perpetrator causing damage to the target person T, and a third person being a surrounding person except for the target person T and a perpetrator.

For example, by building a sensor for detecting biometric information in a strap, a handrail, and the like of the moving vehicle 60, the biometric information acquisition unit 102 may acquire biometric information about other person from the sensor.

For example, a tense state and an excited state of a perpetrator can be detected by acquiring biometric information about the perpetrator. When a tense state before a crime is committed can be detected, caution information such as a message that discourages a crime in advance can also be output.

Further, a tense state and an excited state of surrounding people can be detected by acquiring biometric information about a third person. By counting the number of surrounding people whose biometric information satisfies a first criterion, the decision unit 106 may decide that an incident occurs when the number of people exceeds a threshold value. In this way, an occurrence situation of an incident can be accurately decided.

As described above, in the surveillance apparatus 100 according to the present example embodiment, the biometric information acquisition unit 102 further acquires biometric information about other person, the decision unit 106 decides whether the biometric information about the other person satisfies a third criterion, and the output processing unit 108 outputs predetermined information when the biometric information about the other person satisfies the third criterion. In other words, the decision processing can be performed based on the biometric information about the person P around the target person T, and thus a tense state and an excited state before a crime is committed can be detected.

In this way, the surveillance apparatus 100 according to the present example embodiment can achieve an effect similar to that in the example embodiments described above, and can also perform the decision processing, based on the biometric information about the person P around the target person T, and can thus output the caution information or the predetermined information by detecting a tense state and an excited state before a perpetrator commits a crime, and foreseeing occurrence of an incident such as a crime in advance.

Further, a state of a surrounding person except for a perpetrator can be detected, and thus accuracy of decision of occurrence of an incident can be further improved.

### Seventh Example Embodiment

### Functional Configuration Example

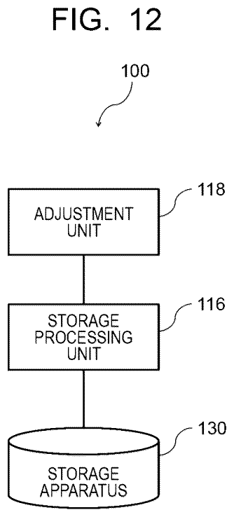

FIG. 12 is a partial functional block diagram illustrating a main configuration of a surveillance apparatus 100 according to an example embodiment.

The present example embodiment is similar to any of the example embodiments described above except for a point of a configuration for accumulating information about an incident detected by a decision unit 106, and adjusting various reference values and threshold values used for decision processing. Hereinafter, the configuration of the present example embodiment can be combined as long as the present example embodiment is not inconsistent with at least any one of configurations of other example embodiments.

The surveillance apparatus 100 further includes a storage processing unit 116 and an adjustment unit 118.

When the decision unit 106 decides that a first criterion and a second criterion are satisfied, the decision unit 106 detects occurrence of an incident. The storage processing unit 116 records incident information 200 in a storage apparatus 130 when the decision unit 106 detects occurrence of an incident.

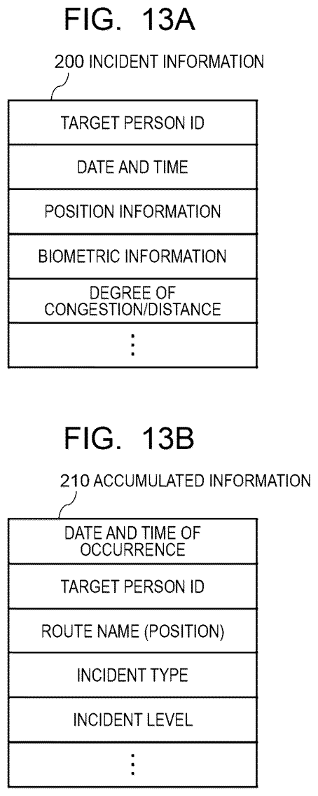

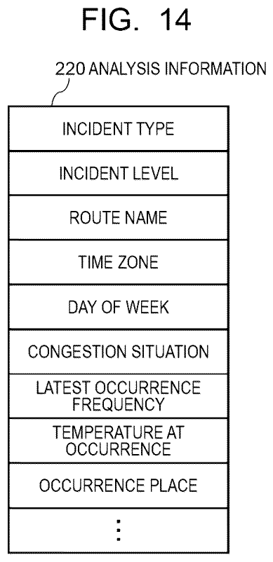

FIGS. 13 and 14 are diagrams illustrating a data structure example of various types of information indicating an occurrence situation of an incident.

The incident information 200 in FIG. 13(a) includes, for example, identification information (target person ID) about a target person T in which occurrence of an incident is detected, a date and time of occurrence of the incident, occurrence position information, biometric information about the target person T being a basis of detection of occurrence of the incident, information about a degree of congestion indicating a state of other person P, a distance between the target person T and the other person P, and the like, which is a basis of detection of occurrence of the incident, and the like. However, FIG. 13(a) is one example, which is not limited thereto. For example, the incident information 200 may be stored in association with image data when occurrence of an incident is detected.

The storage processing unit 116 may accumulate the incident information 200 as accumulated information 210 in order to adjust various reference values and threshold values by the adjustment unit 118. FIG. 13(b) is a diagram illustrating a data structure example of the accumulated information 210. The accumulated information 210 includes a date and time of occurrence of an incident, identification information about the target person T, a route name and position information at occurrence of the incident, a type (such as molestation, theft, violence, and kidnapping) of the incident, and a level of the incident. FIG. 13(b) is one example, which is not limited thereto.

A level of an incident is, for example, information indicating urgency and risk of the incident. The level may be classified into a level of low urgency to the extent of a quarrel between passengers, a level of high risk such as a violence act, a level of both of high urgency and high risk such as occurrence of a crime such as kidnapping, robbery, and murder, and the like.

The storage processing unit 116 may analyze the incident information 200, and accumulate the incident information 200 as the accumulated information 210 in the storage apparatus 130.

The adjustment unit 118 analyzes an occurrence situation of an incident, based on the accumulated information 210. The storage processing unit 116 stores a result of the analysis by the adjustment unit 118 as analysis information 220 in the storage apparatus 130.

FIG. 14 is a diagram illustrating a data structure example of the analysis information 220. The analysis information 220 includes, for example, an incident type, an incident level, a route name, a time zone of occurrence of an incident, a day of the week, a congestion situation, a latest occurrence frequency of the incident, a temperature at occurrence, and an occurrence place (such as a position of a vehicle (a number of a vehicle), and a position in a vehicle, for example, a vicinity of a door, a corner of a vehicle, and the like). FIG. 14 is one example, which is not limited thereto.

For example, the adjustment unit 118 may acquire, as a temperature at occurrence, a temperature of a vehicle from a temperature sensor provided in the vehicle, and may acquire a temperature in an incident occurrence region from weather information at occurrence of the incident.

### Adjustment of Reference Value

The adjustment unit 118 adjusts various reference values and threshold values, based on the analysis information 220. An optimum reference value and an optimum threshold value may be determined and adjusted by season and region. Further, an optimum reference value and an optimum threshold value may be determined and adjusted according to a time zone and a day of the week. Further, a condition that an incident is more likely to occur may be determined by type of an incident, and an optimum reference value and an optimum threshold value may be determined and adjusted.

Adjustment processing of various reference values and threshold values may display information about the analysis information 220 on a screen of a display apparatus 120 and provide the information to an operator U, and may also display a screen for accepting an adjustment by the operator U on the display apparatus 120 and accept setting of an adjusted value.

As described above, in the surveillance apparatus 100 according to the present example embodiment, the adjustment unit 118 analyzes an occurrence situation of an incident, based on the accumulated information 210. The storage processing unit 116 stores a result of the analysis by the adjustment unit 118 as the analysis information 220 in the storage apparatus 130. Then, the adjustment unit 118 adjusts various reference values and threshold values, based on the analysis information 220.

In this way, the surveillance apparatus 100 according to the present example embodiment can determine and adjust an optimum reference value and an optimum threshold value according to a condition, and can thus more accurately detect occurrence of an incident.

While the example embodiments of the present invention have been described with reference to the drawings, the example embodiments are only exemplification of the present invention, and various configurations other than the above-described example embodiments can also be employed.

For example, a main body of the surveillance method in the example embodiments described above is not limited to the computer 1000 of the surveillance apparatus 100. At least one of the camera 5, the target person portable terminal 10, and each computer 1000 of the surveillance apparatus 100 may achieve each function of the surveillance apparatus 100. At least two of the camera 5, the target person portable terminal 10, and each computer 1000 of the surveillance apparatus 100 may be combined and achieve each function of the surveillance apparatus 100 in a shared manner.

Alternatively, the computer 1000 of the camera 5 may have a function of directly communicating with the target person portable terminal 10 of the target person T, and achieve the biometric information acquisition unit 102, the image acquisition unit 104, the decision unit 106, the output processing unit 108, the estimation unit 110, and the determination unit 112.

Alternatively, the computer 1000 of the target person portable terminal 10 may have a function of communicating with the camera 5, and achieve the biometric information acquisition unit 102, the image acquisition unit 104, the decision unit 106, the output processing unit 108, the estimation unit 110, and the determination unit 112.

### Surveillance Example in Case of Nursery School and Facility for Elderly People

Further, when a predetermined space is a nursery school, a facility for elderly people, and the like, the surveillance apparatus 100 may detect occurrence of an incident such as a quarrel between nursery school children or residents, and abuse of a nursery school child or a resident by a staff member, and may report the incident to a staff member or a guardian and a family.

A nursery school child or a resident wears the wearable terminal 20 or a terminal for biometric information acquisition including a sensor that acquires biometric information, and thus the biometric information acquisition unit 102 acquires the biometric information from the terminal via a tablet terminal, a personal computer, and a smartphone, or directly from the terminal. The camera 5 is installed in such a way as to be able to capture a region being a surveillance target in a facility.

The decision unit 106 may decide whether a state where biometric information satisfies a first criterion (at least one of a heart rate and an amount of perspiration exceeds a reference value) and a state of the target person T and the other person P satisfies a second criterion (a distance between the target person T and the other person P is closer than a reference value) continues for a certain period of time.

When the state described above continues for the certain period of time, the output processing unit 108 may output predetermined information. In this way, the decision unit 106 may decide whether the state where the first criterion and the second criterion are satisfied continues for the certain period of time.

The output processing unit 108 outputs the predetermined information to a portable terminal (for example, a smartphone and a tablet terminal) carried by a staff member or a guardian and a family. The output processing unit 108 may perform driving of a rotating lamp installed in a facility, an output of a sound or a warning sound to a speaker, and display of an image and a message on a display.

Destination information (for example, a cellular phone number and an e-mail address) of a portable terminal carried by a staff member or a guardian and a family may be preregistered, and the output processing unit 108 may transmit a message including the predetermined information to the destination. Alternatively, an application for using a service of the surveillance system 1 may be installed in advance and activated in a portable terminal, and the service may be logged in, and thus the portable terminal may be able to acquire and output the predetermined information from the surveillance apparatus 100.

Furthermore, a report may be able to be made to a manager of the nearest police, a predetermined post of a related public office, and the like. The output processing unit 108 may transmit information about occurrence of an incident to a portable terminal carried by a manager. A transmission method is similar to that of a portable terminal of a family and the like described above. Alternatively, driving of a rotating lamp installed at a police station, a predetermined post of a related public office, and the like, an output of a sound or a warning sound to a speaker, and display of an image and a message on a display may be performed.

Further, the plurality of steps (pieces of processing) are described in order in the plurality of flowcharts used in the above-described description, but an execution order of steps performed in each of the example embodiments is not limited to the described order. In each of the example embodiments, an order of illustrated steps may be changed within an extent that there is no harm in context. Further, each of the example embodiments described above can be combined within an extent that a content is not inconsistent.

Although the invention of the present application has been described with reference to the example embodiments, it should be understood that the invention of the present application is not limited to the above-described example embodiments. Various modifications that can be understood by those skilled in the art can be made to the configuration and the details of the invention of the present application within the scope of the invention of the present application.

Note that, when information about a user is acquired and used in the present invention, this is lawfully performed.

A part or the whole of the above-described example embodiment may also be described in supplementary notes below, which is not limited thereto.
1. A surveillance apparatus including:
   a biometric information acquisition unit that acquires biometric information about a target person present in a predetermined space;
   an image acquisition unit that acquires an image including the target person and surroundings of the target person;
   a decision unit that decides whether the biometric information satisfies a first criterion and a state of other person located around the target person satisfies a second criterion; and
   an output processing unit that outputs predetermined information when it is decided that both of the first criterion and the second criterion are satisfied.
2. The surveillance apparatus according to supplementary note 1, wherein
   the predetermined space is an inside of a car of a moving vehicle.
3. The surveillance apparatus according to supplementary note 1 or 2, wherein
   the second criterion includes a condition that a degree of congestion in the predetermined space is equal to or more than a reference value.
4. The surveillance apparatus according to any one of supplementary notes 1 to 3, wherein
   the second criterion includes a condition that the target person is surrounded by a plurality of people.
5. The surveillance apparatus according to any one of supplementary notes 1 to 4, wherein
   the second criterion includes a condition that a distance between the target person and the other person is equal to or less than a reference value.
6. The surveillance apparatus according to any one of supplementary notes 1 to 5, further including
   an estimation unit that estimates an attribute of each of the target person and the other person by image processing, wherein
   the second criterion includes a condition related to the attribute.
7. The surveillance apparatus according to supplementary note 6, wherein
   the attribute includes a condition related to at least one of gender and an age group of at least one of the target person and the other person.
8. The surveillance apparatus according to supplementary note 6 or 7, further including
   a determination unit that determines a position of the target person when the target person whose biometric information is decided to satisfy the first criterion is detected, wherein
   the estimation unit acquires an image including the determined position, and performs the image processing.
9. The surveillance apparatus according to supplementary note 8, further including
   a camera control unit that directs a camera toward the determined position, and causes the camera to generate the image, wherein
   the estimation unit acquires the generated image, and performs the image processing.
10. The surveillance apparatus according to any one of supplementary notes I to 9, wherein
   the biometric information includes at least one of a heart rate and an amount of perspiration.
11. The surveillance apparatus according to supplementary note 10, wherein
   the biometric information acquisition unit acquires the biometric information about the target person from a wearable terminal worn by the target person.
12. The surveillance apparatus according to any one of supplementary notes 1 to 11, wherein
   the output processing unit
      outputs caution information toward the predetermined space before the predetermined information is output, and
      outputs the predetermined information when a state where the first criterion and the second criterion are satisfied continues after the caution information is output.
13. The surveillance apparatus according to supplementary note 12, wherein
   the predetermined space is an inside of a car of a moving vehicle, and
   the output processing unit outputs the predetermined information to at least one of a driver and a manager of the moving vehicle.
14. The surveillance apparatus according to any one of supplementary notes 1 to 13, wherein
   the biometric information acquisition unit further acquires biometric information about the other person,
   the decision unit decides whether the biometric information about the other person satisfies a third criterion, and
   the output processing unit outputs the predetermined information when the biometric information about the other person satisfies the third criterion.
15. A surveillance system including:
   a capturing unit; and
   a surveillance apparatus, wherein
   the surveillance apparatus includes
      a biometric information acquisition unit that acquires biometric information about a target person present in a predetermined space,
      an image acquisition unit that acquires an image including the target person and surroundings of the target person from the capturing unit,
      a decision unit that decides whether the biometric information satisfies a first criterion and a state of other person located around the target person satisfies a second criterion, and
      an output processing unit that outputs predetermined information when it is decided that both of the first criterion and the second criterion are satisfied.
16. The surveillance system according to supplementary note 15, wherein
   the predetermined space is an inside of a car of a moving vehicle.
17. The surveillance system according to supplementary note 15 or 16, wherein
   the second criterion includes a condition that a degree of congestion in the predetermined space is equal to or more than a reference value.
18. The surveillance system according to any one of supplementary notes 15 to 17, wherein
   the second criterion includes a condition that the target person is surrounded by a plurality of people.
19. The surveillance system according to any one of supplementary notes 15 to 18, wherein
   the second criterion includes a condition that a distance between the target person and the other person is equal to or less than a reference value.
20. The surveillance system according to any one of supplementary notes 15 to 19, wherein
   the surveillance apparatus further includes an estimation unit that estimates an attribute of each of the target person and the other person by image processing, and
   the second criterion includes a condition related to the attribute.
21. The surveillance system according to supplementary note 20, wherein
   the attribute includes a condition related to at least one of gender and an age group of at least one of the target person and the other person.
22. The surveillance system according to supplementary note 20 or 21, wherein
   the surveillance apparatus further includes a determination unit that determines a position of the target person when the target person whose biometric information is decided to satisfy the first criterion is detected, and
   the estimation unit of the surveillance apparatus acquires an image including the determined position, and performs the image processing.
23. The surveillance system according to supplementary note 22, wherein
   the surveillance apparatus further includes a camera control unit that directs the capturing unit toward the determined position, and causes the capturing unit to generate the image, and
   the estimation unit of the surveillance apparatus acquires the generated image, and performs the image processing.
24. The surveillance system according to any one of supplementary notes 15 to 23, wherein
   the biometric information includes at least one of a heart rate and an amount of perspiration.
25. The surveillance system according to supplementary note 24, wherein
   the biometric information acquisition unit of the surveillance apparatus acquires the biometric information about the target person from a wearable terminal worn by the target person.
26. The surveillance system according to any one of supplementary notes 15 to 25, wherein,
   in the surveillance apparatus,
   the output processing unit
      outputs caution information toward the predetermined space before the predetermined information is output, and
      outputs the predetermined information when a state where the first criterion and the second criterion are satisfied continues after the caution information is output.
27. The surveillance system according to supplementary note 26, wherein
   the predetermined space is an inside of a car of a moving vehicle, and,
   in the surveillance apparatus,
   the output processing unit outputs the predetermined information to at least one of a driver and a manager of the moving vehicle.
28. The surveillance system according to any one of supplementary notes 15 to 27, wherein,
   in the surveillance apparatus,
   the biometric information acquisition unit further acquires biometric information about the other person,
   the decision unit decides whether the biometric information about the other person satisfies a third criterion, and
   the output processing unit outputs the predetermined information when the biometric information about the other person satisfies the third criterion.
29. A surveillance method including:
   acquiring biometric information about a target person present in a predetermined space;
   acquiring an image including the target person and surroundings of the target person;
   deciding whether the biometric information satisfies a first criterion and a state of other person located around the target person satisfies a second criterion; and
   outputting predetermined information when it is decided that both of the first criterion and the second criterion are satisfied.
30. The surveillance method according to supplementary note 29, wherein
   the predetermined space is an inside of a car of a moving vehicle.
31. The surveillance method according to supplementary note 29 or 30, wherein
   the second criterion includes a condition that a degree of congestion in the predetermined space is equal to or more than a reference value. 32. The surveillance method according to any one of supplementary notes 29 to 31, wherein
   the second criterion includes a condition that the target person is surrounded by a plurality of people.
33. The surveillance method according to any one of supplementary notes 29 to 32, wherein
   the second criterion includes a condition that a distance between the target person and the other person is equal to or less than a reference value.
34. The surveillance method according to any one of supplementary notes 29 to 33, further including
   estimating an attribute of each of the target person and the other person by image processing, wherein
   the second criterion includes a condition related to the attribute.
35. The surveillance method according to supplementary note 34, wherein
   the attribute includes a condition related to at least one of gender and an age group of at least one of the target person and the other person.
36. The surveillance method according to supplementary note 34 or 35, further including:
   determining a position of the target person when the target person whose biometric information is decided to satisfy the first criterion is detected; and
   acquiring an image including the determined position, and performing the image processing.
37. The surveillance method according to supplementary note 36, further including:
   directing a camera toward the determined position, and causing the camera to generate the image; and
   acquiring the generated image, and performing the image processing.
38. The surveillance method according to any one of supplementary notes 29 to 37, wherein
   the biometric information includes at least one of a heart rate and an amount of perspiration.
39. The surveillance method according to supplementary note 38, further including
   acquiring the biometric information about the target person from a wearable terminal worn by the target person.
40. The surveillance method according to any one of supplementary notes 29 to 39, further including:
   outputting caution information toward the predetermined space before the predetermined information is output; and
   outputting the predetermined information when a state where the first criterion and the second criterion are satisfied continues after the caution information is output.
41. The surveillance method according to supplementary note 40, wherein
   the predetermined space is an inside of a car of a moving vehicle, and
   the surveillance method further includes outputting the predetermined information to at least one of a driver and a manager of the moving vehicle.
42. The surveillance method according to any one of supplementary notes 29 to 41, further including:
   further acquiring biometric information about the other person;
   deciding whether the biometric information about the other person satisfies a third criterion; and
   outputting the predetermined information when the biometric information about the other person satisfies the third criterion.
43. A program for causing a computer to execute:
   a procedure of acquiring biometric information about a target person present in a predetermined space;
   a procedure of acquiring an image including the target person and surroundings of the target person;
   a procedure of deciding whether the biometric information satisfies a first criterion and a state of other person located around the target person satisfies a second criterion; and
   a procedure of outputting predetermined information when it is decided that both of the first criterion and the second criterion are satisfied.
44. The program according to supplementary note 43, wherein
   the predetermined space is an inside of a car of a moving vehicle.
45. The program according to supplementary note 43 or 44, wherein
   the second criterion includes a condition that a degree of congestion in the predetermined space is equal to or more than a reference value.
46. The program according to any one of supplementary notes 43 to 45, wherein
   the second criterion includes a condition that the target person is surrounded by a plurality of people.
47. The program according to any one of supplementary notes 43 to 46, wherein
   the second criterion includes a condition that a distance between the target person and the other person is equal to or less than a reference value.
48. The program according to any one of supplementary notes 43 to 47, further causing a computer to execute
   a procedure of estimating an attribute of each of the target person and the other person by image processing, wherein
   the second criterion includes a condition related to the attribute.
49. The program according to supplementary note 48, wherein
   the attribute includes a condition related to at least one of gender and an age group of at least one of the target person and the other person.
50. The program according to supplementary note 48 or 49, further causing a computer to execute
   a procedure of determining a position of the target person when the target person whose biometric information is decided to satisfy the first criterion is detected, wherein,
   in the estimation procedure, an image including the determined position is acquired, and the image processing is performed.
51. The program according to supplementary note 50, further causing a computer to execute
   a procedure of directing a camera toward the determined position, and causing the camera to generate the image, wherein,
   in the estimation procedure, the generated image is acquired, and the image processing is performed.
52. The program according to any one of supplementary notes 43 to 51, wherein
   the biometric information includes at least one of a heart rate and an amount of perspiration.
53. The program according to supplementary note 52, wherein,
   in the procedure of acquiring the biometric information, the biometric information about the target person is acquired from a wearable terminal worn by the target person.
54. The program according to any one of supplementary notes 43 to 53, wherein,
   in the output procedure,
   caution information is output to the predetermined space before the predetermined information is output; and
   the predetermined information is output when a state where the first criterion and the second criterion are satisfied continues after the caution information is output.
55. The program according to supplementary note 54, wherein
   the predetermined space is an inside of a car of a moving vehicle, and,
   in the output procedure,
   the predetermined information is output to at least one of a driver and a manager of the moving vehicle.
56. The program according to any one of supplementary notes 43 to 55, wherein,
   in the procedure of acquiring the biometric information, biometric information about the other person is further acquired,
   in the decision procedure, whether the biometric information about the other person satisfies a third criterion is determined, and,
   in the output procedure, the predetermined information is output when the biometric information about the other person satisfies the third criterion.
57. A computer-readable storage medium that stores a program for causing a computer to execute:
   a procedure of acquiring biometric information about a target person present in a predetermined space;
   a procedure of acquiring an image including the target person and surroundings of the target person;
   a procedure of deciding whether the biometric information satisfies a first criterion and a state of other person located around the target person satisfies a second criterion; and
   a procedure of outputting predetermined information when it is decided that both of the first criterion and the second criterion are satisfied.
58. The computer-readable storage medium that stores a program according to supplementary note 57, wherein
   the predetermined space is an inside of a car of a moving vehicle.
59. The computer-readable storage medium that stores a program according to supplementary note 57 or 58, wherein
   the second criterion includes a condition that a degree of congestion in the predetermined space is equal to or more than a reference value.
60. The computer-readable storage medium that stores a program according to any one of supplementary notes 57 to 59, wherein
   the second criterion includes a condition that the target person is surrounded by a plurality of people.
61. The computer-readable storage medium that stores a program according to any one of supplementary notes 57 to 60, wherein
   the second criterion includes a condition that a distance between the target person and the other person is equal to or less than a reference value.
62. The computer-readable storage medium that stores a program according to any one of supplementary notes 57 to 61, further causing a computer to execute
   a procedure of estimating an attribute of each of the target person and the other person by image processing, wherein
   the second criterion includes a condition related to the attribute.
63. The computer-readable storage medium that stores a program according to supplementary note 62, wherein
   the attribute includes a condition related to at least one of gender and an age group of at least one of the target person and the other person.
64. The computer-readable storage medium that stores a program according to supplementary note 62 or 63, further causing a computer to execute
   a procedure of determining a position of the target person when the target person whose biometric information is decided to satisfy the first criterion is detected, wherein,
   in the estimation procedure, an image including the determined position is acquired, and the image processing is performed.
65. The computer-readable storage medium that stores a program according to supplementary note 64, further causing a computer to execute
   a procedure of directing a camera toward the determined position, and causing the camera to generate the image, wherein,
   in the estimation procedure, the generated image is acquired, and the image processing is performed.
66. The computer-readable storage medium that stores a program according to any one of supplementary notes 57 to 65, wherein
   the biometric information includes at least one of a heart rate and an amount of perspiration.
67. The computer-readable storage medium that stores a program according to supplementary note 66, wherein,
   in the procedure of acquiring the biometric information, the biometric information about the target person is acquired from a wearable terminal worn by the target person.
68. The computer-readable storage medium that stores a program according to any one of supplementary notes 57 to 67, wherein,
   in the output procedure,
   caution information is output to the predetermined space before the predetermined information is output; and
   the predetermined information is output when a state where the first criterion and the second criterion are satisfied continues after the caution information is output.
69. The computer-readable storage medium that stores a program according to supplementary note 68, wherein
   the predetermined space is an inside of a car of a moving vehicle, and,
   in the output procedure,
   the predetermined information is output to at least one of a driver and a manager of the moving vehicle.
70. The computer-readable storage medium that stores a program according to any one of supplementary notes 57 to 69, wherein,
   in the procedure of acquiring the biometric information, biometric information about the other person is further acquired,
   in the decision procedure, whether the biometric information about the other person satisfies a third criterion is decided, and,
   in the output procedure, the predetermined information is output when the biometric information about the other person satisfies the third criterion.

### REFERENCE SIGNS LIST

1 Surveillance system
3 Communication network
5 Camera
7 In-car speaker
10 Target person portable terminal
20 Wearable terminal
30 Station employee terminal
40 On-premises speaker
50 Headphone
60 Moving vehicle
100 Surveillance apparatus
102 Biometric information acquisition unit
104 Image acquisition unit
106 Decision unit
108 Output processing unit
110 Estimation unit
112 Determination unit
114 Camera control unit
116 Storage processing unit
118 Adjustment unit
120 Display apparatus
130 Storage apparatus
200 Incident information
210 Accumulated information
220 Analysis information
1000 Computer
1010 Bus
1020 Processor
1030 Memory
1040 Storage device
1050 Input/output interface
1060 Network interface

What is claimed is:

1. A surveillance apparatus comprising:
at least one memory store instructions; and
at least one processor configured to execute the instructions to:
acquire biometric information about a target person present in a predetermined space;
acquire an image including the target person and surroundings of the target person;
decide whether the biometric information satisfies a first criterion and a state of other person located around the target person satisfies a second criterion; and
output predetermined information when it is decided that both of the first criterion and the second criterion are satisfied.

2. The surveillance apparatus according to claim 1, wherein
the predetermined space is an inside of a car of a moving vehicle.

3. The surveillance apparatus according to claim 1, wherein
the second criterion includes a condition that a degree of congestion in the predetermined space is equal to or more than a reference value.

4. The surveillance apparatus according to claim 1, wherein
the second criterion includes a condition that the target person is surrounded by a plurality of people.

5. The surveillance apparatus according to claim 1, wherein
the second criterion includes a condition that a distance between the target person and the other person is equal to or less than a reference value.

6. The surveillance apparatus according to claim 1, wherein the at least one processor is further configured to execute the instructions to
estimate an attribute of each of the target person and the other person by image processing, and
the second criterion includes a condition related to the attribute.

7. The surveillance apparatus according to claim 6, wherein
the attribute includes a condition related to at least one of gender and an age group of at least one of the target person and the other person.

8. The surveillance apparatus according to claim 6, wherein the at least one processor is further configured to execute the instructions to:
determine a position of the target person when the target person whose biometric information is decided to satisfy the first criterion is detected;
acquire an image including the determined position, and on which performs the image processing.

9. The surveillance apparatus according to claim 8, wherein the at least one processor is further configured to execute the instructions to:
direct a camera toward the determined position, and cause the camera to generate the image;
acquire the generated image, and on which performs the image processing.

10. The surveillance apparatus according to claim 1, wherein
the biometric information includes at least one of a heart rate and an amount of perspiration.

11. The surveillance apparatus according to claim 10, wherein
the at least one processor is further configured to execute the instructions to
acquire the biometric information about the target person from a wearable terminal worn by the target person.

12. The surveillance apparatus according to claim 1, wherein
the at least one processor is further configured to execute the instructions to
output caution information toward the predetermined space before the predetermined information is output, and
output the predetermined information when a state where the first criterion and the second criterion are satisfied continues after the caution information is output.

13. The surveillance apparatus according to claim 12, wherein
the predetermined space is an inside of a car of a moving vehicle, and
the at least one processor is further configured to execute the instructions to
output the predetermined information to at least one of a driver and a manager of the moving vehicle.

14. The surveillance apparatus according to claim 1, wherein
the at least one processor is further configured to execute the instructions to
further acquire biometric information about the other person,
decide whether the biometric information about the other person satisfies a third criterion, and
output the predetermined information when the biometric information about the other person satisfies the third criterion.

15. (canceled)

16. A surveillance method comprising:
acquiring biometric information about a target person present in a predetermined space;
acquiring an image including the target person and surroundings of the target person;
deciding whether the biometric information satisfies a first criterion and a state of other person located around the target person satisfies a second criterion; and
outputting predetermined information when it is decided that both of the first criterion and the second criterion are satisfied.

17. A non-transitory computer-readable medium that stores a program for causing a computer to execute:
acquiring biometric information about a target person present in a predetermined space;
acquiring an image including the target person and surroundings of the target person;
deciding whether the biometric information satisfies a first criterion and a state of other person located around the target person satisfies a second criterion; and
outputting predetermined information when it is decided that both of the first criterion and the second criterion are satisfied.
